(19) United States
(12) Patent Application Publication
(10) Pub. No.: US 2021/0224745 A1
(43) Pub. Date: Jul. 22, 2021

(54) METHODS AND SYSTEMS OF AN UNBIASED MIDDLE ENTITY TO LEGALLY VERIFY AND MANAGE CONSUMER CONSENT OR ACCEPTANCE

(71) Applicants: MEYYAPPAN ALAGAPPAN, FREMONT, CA (US); RAJ KISHOR KHAWARE, PLEASANTON, CA (US)

(72) Inventors: MEYYAPPAN ALAGAPPAN, FREMONT, CA (US); RAJ KISHOR KHAWARE, PLEASANTON, CA (US)

(21) Appl. No.: 16/746,278

(22) Filed: Jan. 17, 2020

(51) Int. Cl. G06Q 10/10; G06Q 50/26; G06Q 30/00; G06Q 40/02; G06Q 50/18; G06Q 50/00; G06Q 40/00; G06F 21/30

(52) U.S. Cl. CPC G06Q 10/10; G06Q 50/265; G06Q 30/016; G06Q 40/02; G06Q 50/18; G06F 9/541; G06Q 40/12; G06Q 30/0185; G06F 21/30; G06F 2221/2115; G06Q 50/01

(57) ABSTRACT

In one aspect, a digitized solution for an unbiased entity is provided to attest or certify an acceptance of specified policies or agreements between a corporate entity and their customers or users. In yet another aspect, digitized solution for implementing an automated audit systems to periodically verify the user acceptance details with the corporate entity and how such acceptance are enforced by the corporate entity.

### BACKGROUND

User privacy has become an important aspect of social life. Governments around the world have passed regulations to safeguard user privacy. These regulations often require corporates to obtain a formal acceptance or consent for their privacy agreement with the consumers before collecting their privacy information. Unfortunately, the acceptance of this agreement is not legally verifiable as it may be directly collected by the corporations through their websites. At any point of time the user or the corporate can deny this acceptance or the agreement terms as no third party is involved to attest this acceptance. Therefore, an unbiased middle entity can be used to improve this process by attesting and verifying the privacy agreement acceptance between the user and the corporation.

### BRIEF SUMMARY OF THE INVENTION

In one aspect, a digitized solution for an unbiased entity attests or certifies an acceptance of policy agreement between a corporate entity and their customers or users.

Optionally, the policy agreement includes a privacy policy such as a GDPR-based privacy policy, a CCPA-based privacy policy, a custom corporate privacy policy or other privacy policies. The digitized solution provides a website accessible via a computer network, wherein the website comprises a set of interactive web pages, and wherein the website is maintained by a corporate entity. With at least one of the interactive web pages, the digitized solution displays a privacy policy agreement to users using the website, and enables an unbiased entity to receive the user acceptance.

In another aspect, a digitized solution for implementing a user acceptance of specified policies or agreements created by a corporate entity with an unbiased middle entity comprising enabling an authorized personnel to setup a specified policies or agreement filter with an unbiased middle entity.

In yet another aspect, digitized solution for implementing an automated audit systems to periodically verify the user acceptance details with the corporate entity and how such acceptance are enforced by the corporate entity.

### BRIEF DESCRIPTION OF THE DRAWINGS

FIG. 1 illustrates an example process for implementing an unbiased middle entity to manage private data, according to some embodiments.

FIGS. 2 A-D illustrate example screenshots for implementing process 100, according to some embodiments.

FIG. 3 illustrates an example process for policy authorization/setup flow, according to some embodiments.

FIG. 4 illustrates another example process for policy authorization/setup Flow, according to some embodiments.

FIG. 5 illustrates yet another example process for policy authorization/setup flow, according to some embodiments.

FIG. 6 illustrates an example process for dispute resolution, according to some embodiments.

The figures described above are a representative set, and are not an exhaustive with respect to embodying the invention.

### DESCRIPTION

Disclosed are a system, method, and article of an unbiased middle entity to legally verify and manage consumer consent or acceptance. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

California Consumer Privacy Act (CCPA) is a bill that enhances privacy rights and consumer protection for residents of California, United States. The bill was passed by the California State Legislature and signed into law by Jerry Brown, Governor of California, on Jun. 28, 2018, to amend Part 4 of Division 3 of the California Civil Code.

HTTP cookie (e.g. a cookie) is a small piece of data sent from a website and stored on the user's computer by the user's web browser while the user is browsing. Cookies can be used by a websites as a mechanism to remember stateful information (e.g. as items added in the shopping cart in an online store) and/or to record the user's browsing activity (e.g. clicking specified buttons, logging in, recording visited in the past, etc.).

General Data Protection Regulation (GDPR) is a regulation in EU law on data protection and privacy for all individual citizens of the European Union (EU) and the European Economic Area (EEA). It also addresses the transfer of personal data outside the EU and EEA areas. The GDPR aims primarily to give control to individuals over their personal data and to simplify the regulatory environment for international business by unifying the regulation within the EU.

Children's Online Privacy Protection Act of 1998 (COPPA) is a United States federal law that applies to the online collection of personal information by persons or entities under U.S. jurisdiction about children under 13 years of age including children outside the U.S., if the company is U.S.-based. It details what a website operator must include in a privacy policy, when and how to seek verifiable consent from a parent or guardian, and what responsibilities an operator has to protect children's privacy and safety online including restrictions on the marketing of those under 13.

### Example Methods

Webpages may collect private user information. Websites can request that the users provide various permissions with respect to the collected private user information. Additionally, governmental entities may require various website actions with respect to private user data as well. Examples include, inter alia: GDPR, CCPA, etc. Example methods provided herein provide an unbiased and trusted middle entity to manage user privacy states and settings. Entities (e.g. corporations, education institutions, etc.) can access the middle entity to obtain the user privacy states and settings. Based on these user privacy states and settings, entities can collect various information about the user's behavior on a website. Additional example methods provided herein can be used to manage the lifecycle of a user's data with proper privacy filters.

Unbiased Middle Entity to Safeguard the Approval Process

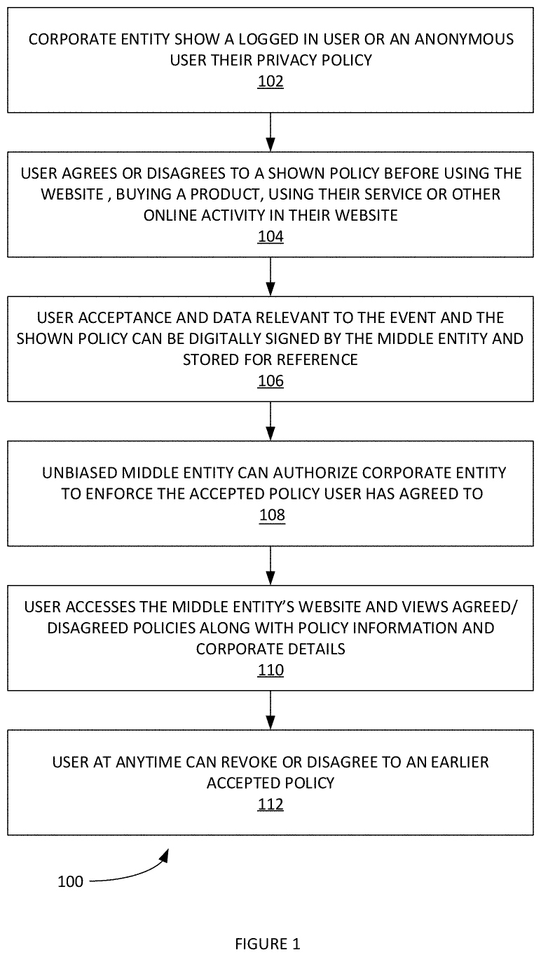

FIG. 1 illustrates an example process 100 for implementing an unbiased middle entity to manage private data, according to some embodiments. In step 102, process 100 can be used by a corporate entity to show a logged in user or an anonymous user their privacy policy and/or agreement(s). It is noted that a corporate entity can be any entity. For example, corporate entity can include/be other types of entities, such as, inter alia: non-profit entities, educational entities, religion organizations, athletic organizations, etc.

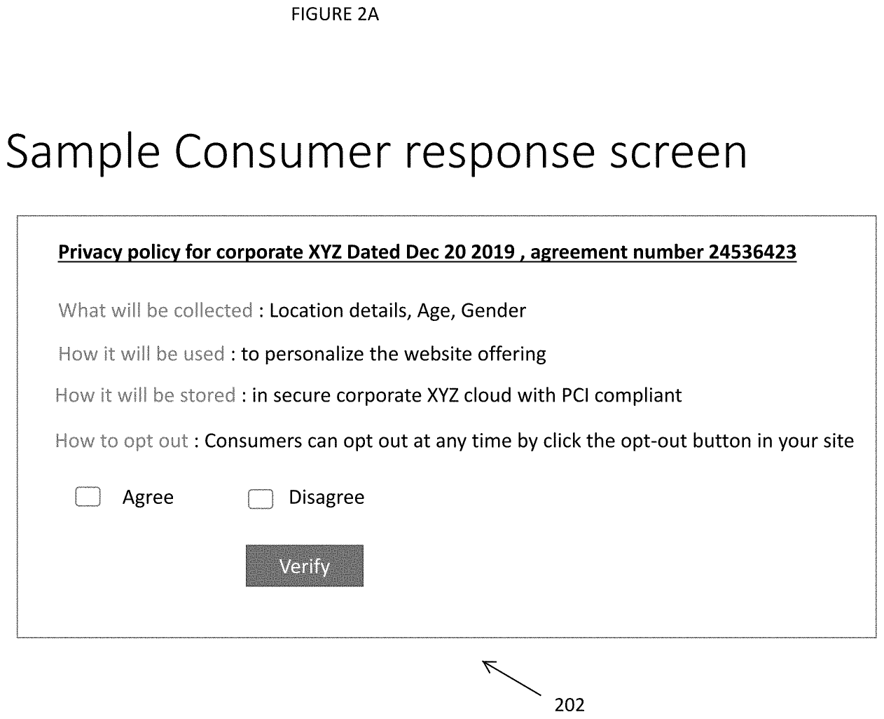

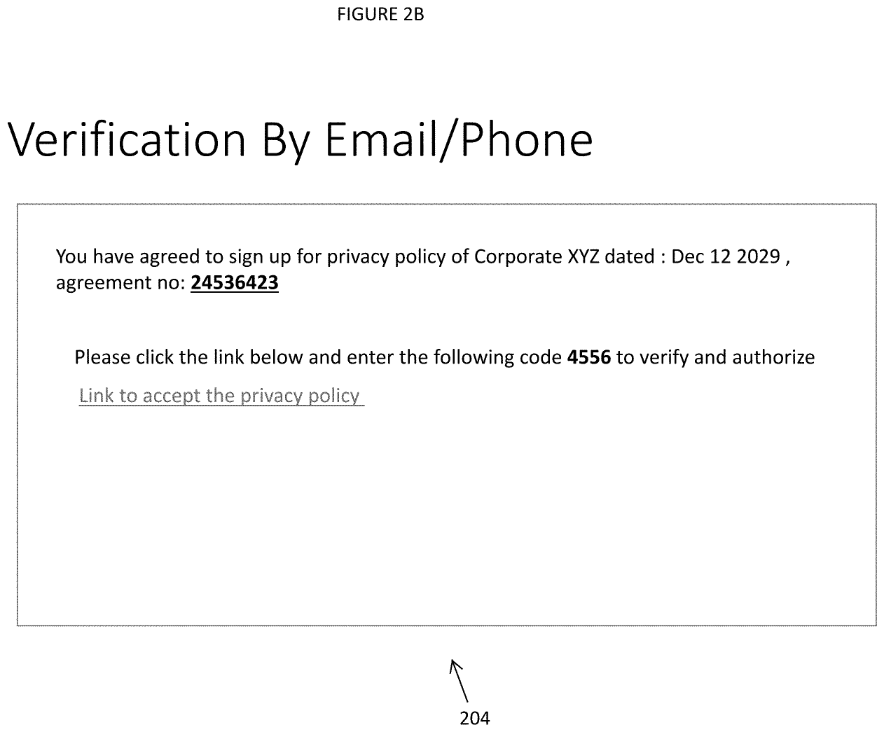

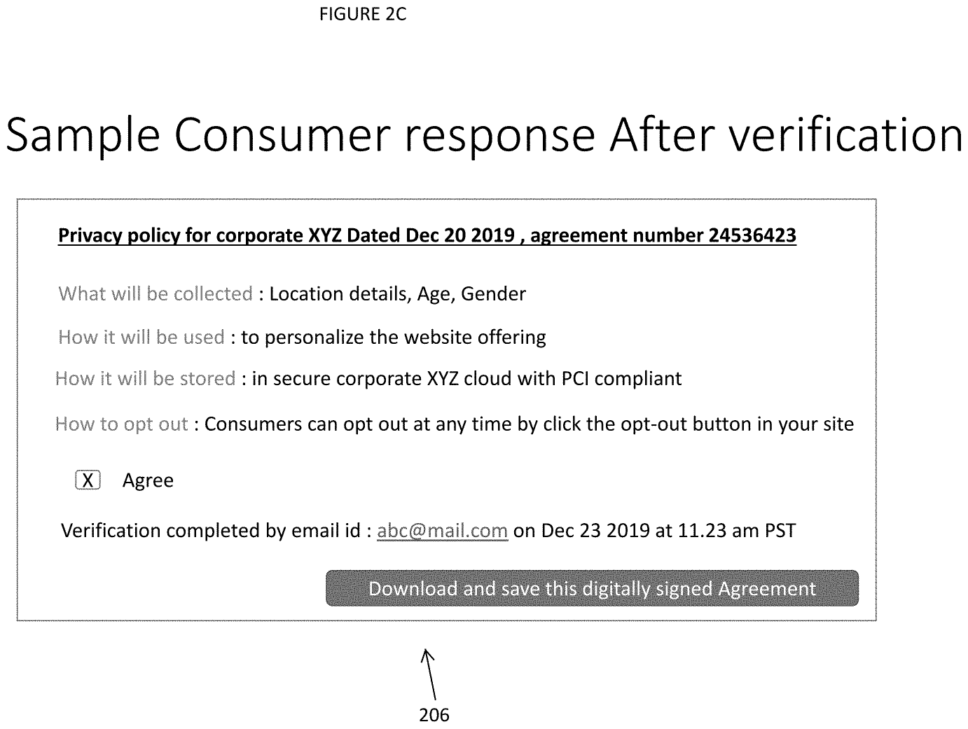

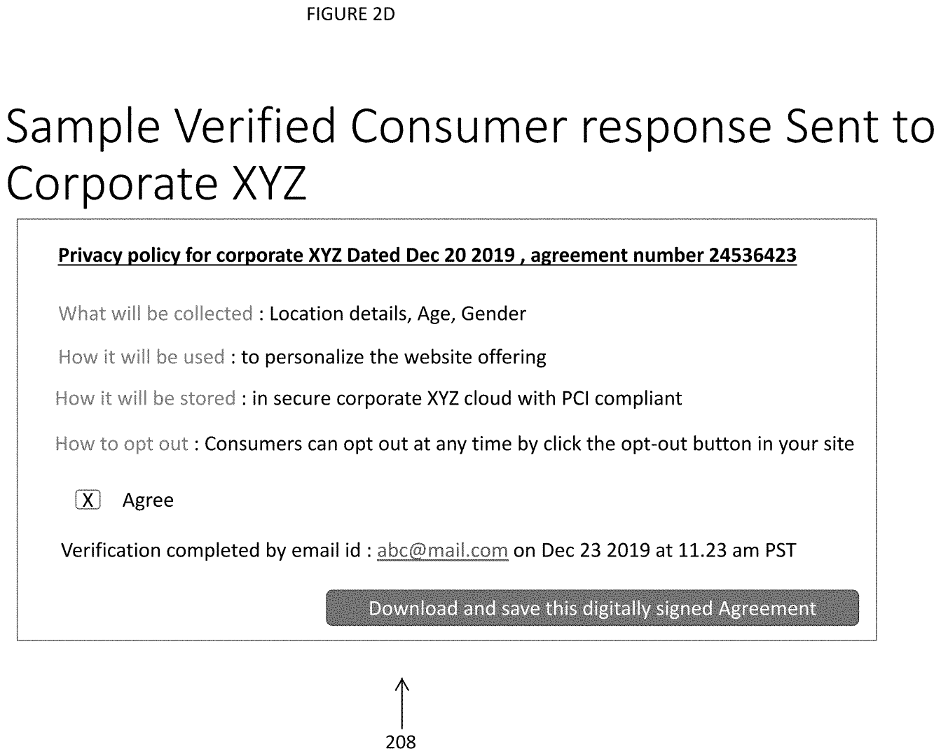

Privacy policies can be based on GRPR, CCPA, COPRA, etc. Furthermore step 102 can also include other policies and agreements such as but not limited to purchase agreement, website usage agreement, refund policy, subscription policy, return policy. FIG. 2A, infra, illustrates an example implementation of step 102.

In step 104, the logged in or anonymous user can agree or disagree to a shown policy before using their website, buying a product, using their service or other online activity in their website. In step 104, user's consent or acceptance for a shown policy can be captured along with other data such as location, IP address, device information, time of occurrence. FIG. 2B, infra, illustrates an example of a verification by email/phone screen as an implementation of step 104. FIG. 2C, infra, illustrates an example sample consumer response after verification. FIG. 2D, infra, also illustrates an example sample verified consumer response sent to an example corporate entity.

In step 106, this user acceptance and/or data relevant to the event and/or the shown policy can be digitally signed by the middle entity and stored for reference. At a later point, the user and/or corporate entity can access and/or download this digitally signed agreement.

In step 108, the unbiased middle entity can authorize the corporate entity to enforce the accepted policy id user has agreed. If the user has disagreed the middle entity will inform the corporate entity not to enforce such a policy

In step 110, user can, at any time, access the middle entity's website and view all the agreed/disagreed policies along with all the policy information and corporate details. This operation can be done using an interactive tool.

User can update/revoke the agreed/disagreed policies. Accordingly, in step 112, user at any time can revoke or disagree to an earlier accepted policy.

FIGS. 2 A-D illustrate example screenshots 202-208 for implementing process 100, according to some embodiments. FIGS. 2 A-D illustrate what data will be collected and how it will be used. They also illustrate the entity(s) obtaining the data. They further show how the data will be stored and how/if users can later opt out of the agreement. FIGS. 2 A-D illustrate can provide various user interface GUI elements for users to modified, agree/not agree to, etc. with the terms provided.

More specifically, FIG. 2A illustrates an example screen shot 202 of a sample verified consumer response sent to an example corporate entity. FIG. 2B illustrates an example screen shot 204 of a verification by email/phone screen as an implementation of step 104. This information can be stored by an unbiased middle entity (e.g. unbiased middle entity 306 infra). FIG. 2C illustrates an example screen shot 206 of a sample consumer response after verification. FIG. 2D also illustrates an example screen shot 208 of a sample verified consumer response sent to an example corporate entity.

### Additional Example Processes

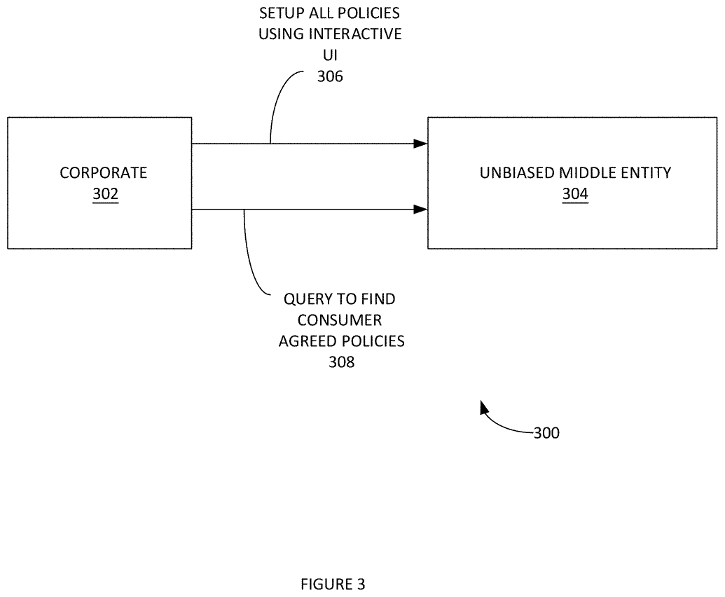

FIG. 3 illustrates an example process 300 for policy authorization/setup flow, according to some embodiments. Process 300 can be implemented between corporate 302 and unbiased middle entity 304. In step 306, process 300 can setup all policies (along with various versions) using interactive UI. In step 308, process 300 can query to find consumer agreed policies.

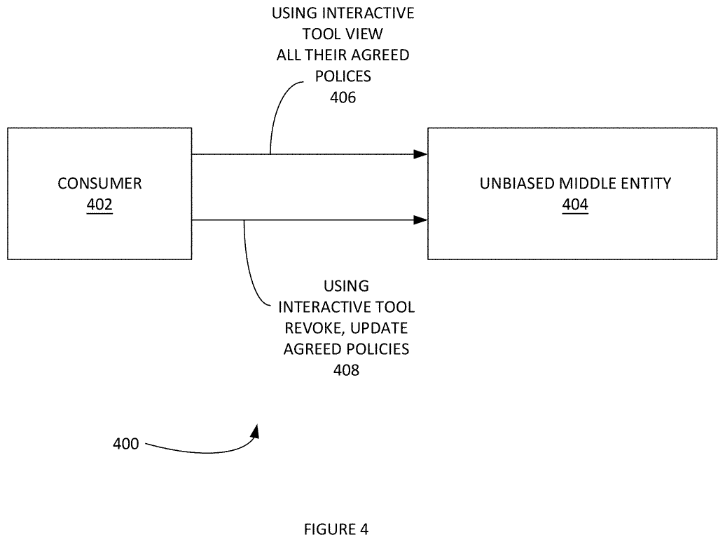

FIG. 4 illustrates an example process 400 for policy authorization/setup Flow, according to some embodiments. Process 400 can be implemented by consumer 402 and unbiased middle entity 404. In step 406, process 400 can Using interactive tool view all their agreed polices. In step 408, process 400 can use an interactive tool revoke/update agreed policies.

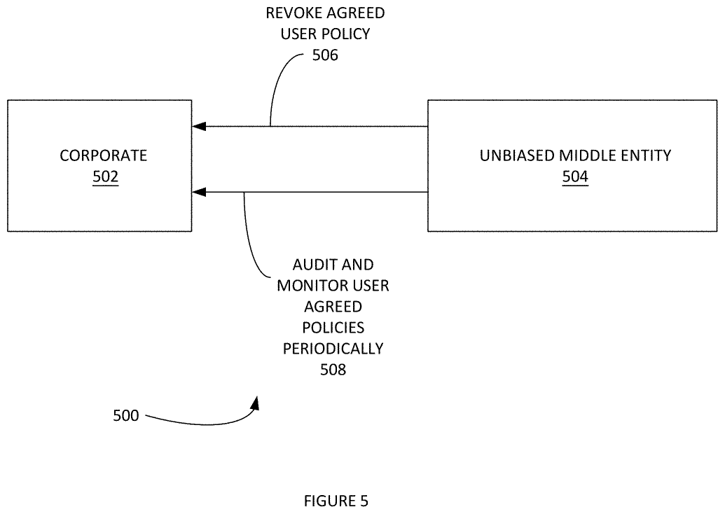

FIG. 5 illustrates an example process 500 for policy authorization/setup flow, according to some embodiments. Process 500 can be implemented between corporate 502 and an unbiased middle entity 504. In step 506, process 500 can revoke agreed user policy. In step 508, process 500 can audit and monitor user agreed policies periodically.

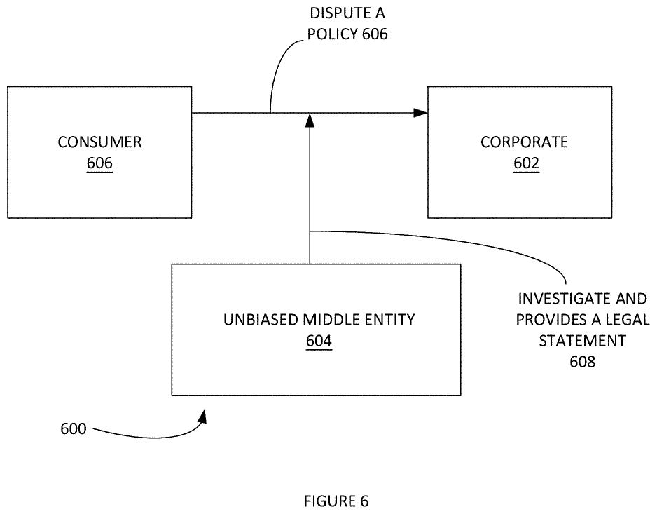

FIG. 6 illustrates an example process 600 for dispute resolution, according to some embodiments. Process 600 can be implemented between corporate 602, unbiased middle entity 604 and consumer 606. In step 608, process 600 can enable consumer 606 to dispute a policy. In step 608, process 600 can enable unbiased middle entity 604 to investigates and provides a legal statement.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent:

1. A digitized solution for an unbiased entity to attest or certify an acceptance or consent of policy agreement between a corporate entity and their customers or users.

2. The digitized solution of claim 1, wherein the policy agreement comprises privacy policy such as a GDPR-based privacy policy, a CCPA-based privacy policy, a custom corporate privacy policy or other privacy policies.

3. The digitized solution of claim 1, wherein the policy agreement further comprises HIPPA, FERRA, GLBA or other regulated policies.

4. The digitized solution of claim 1, wherein the policy agreement further comprises renewal policy, a return policy, a subscription policy or any other policies.

5. The digitized solution of claim 1, wherein the policy agreement can also refer to digital communication or digital notice between corporate entity and their customers such financial statements, release of tax documents, legal notices, alerts and others.

6. The digitized solution of claim 1 further comprising:
a system where user acceptance or consent of a displayed policy agreement in a corporate website can be digitally and securely transferred to the unbiased third-party to validate the user's acceptance or consent; and
a system to digitally store the user acceptance or consent after successful validation.

7. The digitized solution of claim 6, further comprising a system to collect and store the acceptance or consent along with a user specific information, a time, a location, an IP address and other relevant details.

8. The digitized solution of claim 6, further comprising a system to validate user acceptance using email, phone or other mechanisms.

9. The digitized solution of claim 6, further comprising a system to send the validated consent along with an agreement details in a digitally signed by the unbiased entity to the user and corporate as an attested evidence.

10. The digitized solution of claim 6, further comprising a system to authorize the corporate entity regarding the user acceptance so corporate entity can act accordingly.

11. The digitized solution of claim 6, further comprising a system for users or corporate entity to access, view, search the acceptances of the agreements.

12. The digitized solution of claim 6, further comprising a system for users or the corporate entity to revoke or terminate the acceptance provided earlier.

13. The digitized solution of claim 6, further comprising a system for corporate to send notices or alerts to users about regulated or important events that has occurred during the policy enforcement period.

14. The digitized solution of claim 6, further comprising a system for users to request information about the policy such as what data is being collected, how they are being used, how long they are being stored.

15. A digitized solution for implementing an automated audit systems to periodically verify the user acceptance details with the corporate entity and how such acceptance are enforced by the corporate entity.

16. The digitized solution of claim 15, further comprising a setting on the frequency of audits, level of audits, reports generation for audit and recommendation for any audit shortfalls.

17. The digitized solution of claim 15, further comprising an audit conducted through an exposed API.

18. The digitized solution of claim 5 further comprising an audit conducted through installing software agent running behind the corporate firewall.

19. The digitized solution of claim 15, further comprising a test automation system to periodically verify the life cycle flow of user acceptance for an agreement.
